(19) United States
(12) Patent Application Publication
(10) Pub. No.: US 2009/0259987 A1
(43) Pub. Date: Oct. 15, 2009

(54) METHOD, SYSTEM AND COMPUTER PROGRAM PRODUCT FOR RECOMMENDING COMPONENTS BASED ON COMMON USAGE PATTERNS

(75) Inventors: Lawrence Bergman, Mount Kisco, NY (US); Ravi B. Konuru, Tarrytown, NY (US); Richard D. Thompson, Trumbull, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/101,493

(22) Filed: Apr. 11, 2008

(51) Int. Cl. G06F 9/44

(52) U.S. Cl. 717/107

(57) ABSTRACT

A method of recommending a next component includes: identifying one or more candidate software applications based on a first similarity metric, wherein the one or more candidate software applications include one or more reusable software components; identifying one or more candidate software components from the one or more reusable software components based on a second similarity metric; estimating a score for each of the one or more candidate software components based on a composition of the one or more candidate software applications; and generating a recommendation based on the scores of each of the one or more candidate components.

### BACKGROUND

1. Field

This invention relates to methods and systems for recommending next components, and particularly to methods and systems for recommending next components based on common usage patterns.

2. Description of Background

A mashup is a web application that combines data from multiple sources into a single integrated tool, thereby creating new and distinct web services. Mashup development systems typically present users with component options that can be used for assembling these mashups. Depending on the source, the component options can be numerous.

At each stage in the development process of these mashups or applications, the developer must know which components to select. Minimal assistance in the selection process is offered by the development system. In one example, the development system provides a set of categories from which components can be selected. Particularly for novice developers, the problem of selecting the “right” next component from these categories can be daunting, especially in cases where there are multiple unrelated sources.

### SUMMARY

The shortcomings of the prior art are overcome and additional advantages are provided through the provision of a method of recommending a next component. The method includes: identifying one or more candidate software applications based on a first similarity metric, wherein the one or more candidate software applications include one or more reusable software components; identifying one or more candidate software components from the one or more reusable software components based on a second similarity metric; estimating a score for each of the one or more candidate software components based on a composition of the one or more candidate software applications; and generating a recommendation based on the scores of each of the one or more candidate components.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a developer can be given a set of specific recommendations that are more likely to be useful. The developer can be confident in the recommendation because it is based on a similarity between the application being assembled and already-built applications.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings.

FIG. 1 is a block diagram illustrating a computing system that includes a component recommendation system in accordance with an exemplary embodiment.

FIG. 2 is a block diagram illustrating the component recommendation system in accordance with an exemplary embodiment.

FIG. 3 is a block diagram illustrating an application matcher of the component recommendation system in accordance with an exemplary embodiment.

FIG. 4 is a block diagram illustrating a next component extractor of the component recommendation system in accordance with an exemplary embodiment.

FIG. 5 is a block diagram illustrating a next component sorter of the component recommendation system in accordance with an exemplary embodiment.

FIG. 6 is a flowchart illustrating an application matching method that can be performed by the application matcher in accordance with an exemplary embodiment.

FIG. 7 is a flowchart illustrating a next component and component sorting method that can be performed by the next component extractor and the next component sorter in accordance with an exemplary embodiment.

The detailed description explains the preferred embodiments of the invention, together with advantages and features, by way of example with reference to the drawings.

### DETAILED DESCRIPTION

An exemplary embodiment of the present invention provides a system, method and computer program product for collecting information from previously constructed applications, and using that information to recommend next components to developers. The recommendations are based on a set of already assembled components within a partially-built application.

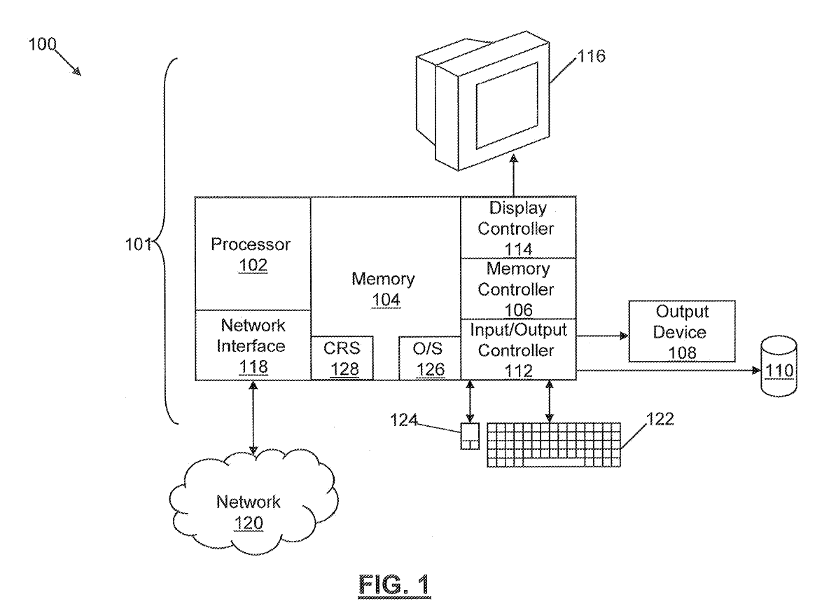

Turning now to FIG. 1, a block diagram illustrates an exemplary computing system 100 that includes a component recommendation system in accordance with the present disclosure. The computing system 100 is shown to include a computer 101. As can be appreciated, the computing system 100 can include any computing device, including but not limited to, a desktop computer, a laptop, a server, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, the system 100 can further include a network interface 118 for coupling to a network 120. The network 120 transmits and receives data between the computer 101 and external systems. In an exemplary embodiment, a conventional keyboard 122 and mouse 124 can be coupled to the input/output controller 112.

In various embodiments, the memory 104 stores instructions that can be executed by the processor 102. The instructions stored in memory 104 may include one or more separate programs, each of which comprises an ordered listing of executable instructions for implementing logical functions. In the example of FIG. 1, the instructions stored in the memory 104 include at least a suitable operating system (OS) 126. The operating system 126 essentially controls the execution of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of the component recommendation system 128 of the present disclosure. In various embodiments, the component recommendation system 128 of the present disclosure is stored in the memory 104 (as shown), is executed from a portable storage device (e.g., CD-ROM, Diskette, FlashDrive, etc.) (not shown), and/or is run from a remote location, such as from a central server (not shown).

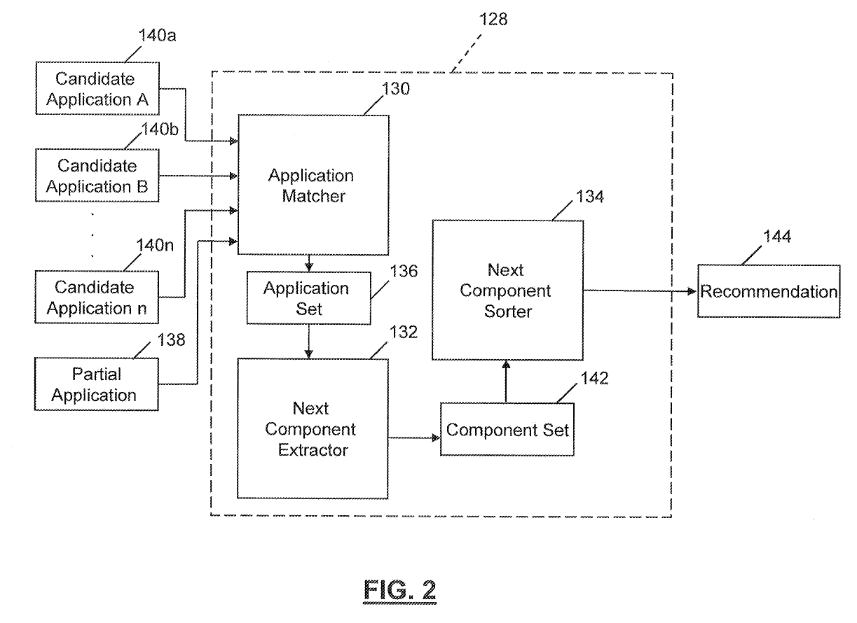

As shown in FIG. 2, the component recommendation system 128 includes an application matcher 130, a next component extractor 132, and a next component sorter 134. Generally speaking, the application matcher 130 extracts a set of matching applications 136, using a partially constructed application 138 and a set of one or more candidate applications 140a-140n. Based on the set of matching applications 136, the next component extractor 132 determines a component set 142 that includes components from within the candidate applications 140a-140n that could potentially be a next component. The next component sorter 134 generates a recommendation 144 of next components by imparting a ranking scheme on the components within the component set 142. In various embodiments, the recommendation 144 includes the highest ranking component. In various other embodiments, the recommendation 144 includes all or a subset of the components of the component set 142 in a ranking order.

In one example, the partial application 138 and the candidate applications 140a-140n are any composite software-based entities, for example, web pages, or application user interfaces (UIs). In this case, the recommendation 140 can be used by a developer to select an appropriate next component during development. As can be appreciated, the partial application 138 and the candidate applications 140a-140n can be any software, hardware, or service that is defined by one or more reusable sub-components.

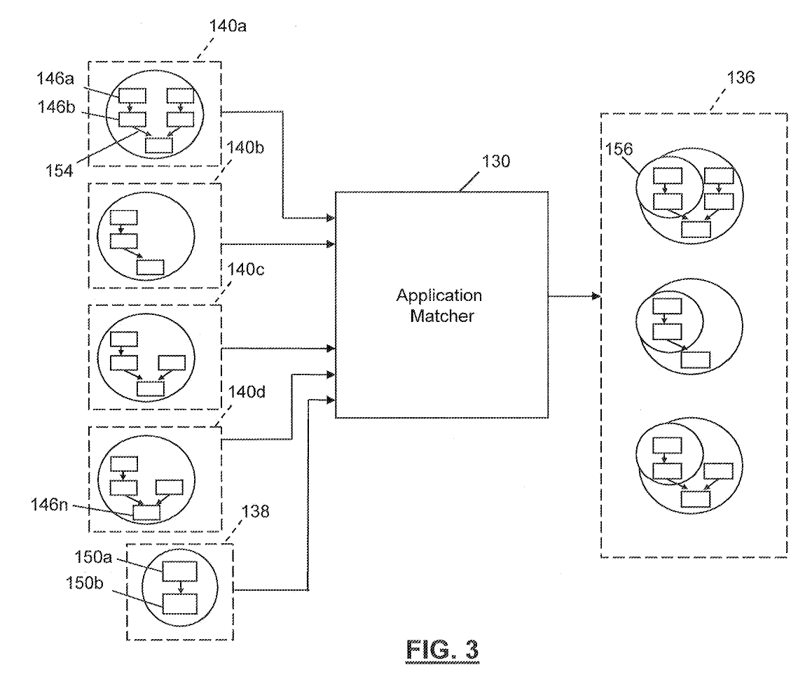

Turning now to FIG. 3, a block diagram illustrates the application matcher 130 of FIG. 2 in accordance with various aspects of the present disclosure. As shown, the candidate applications 140a, 140b, 140c, and 140d each include one or more components 146a-146n. The components 146a-146n can be any sub-entity of an application, for example, a module, a portlet, or a widget. Similarly, the partially constructed application 138 includes one or more components 150a, 150b. In various embodiments, the components 146a-146n and 150a, 150b can be associated by one or more connections 154. The connections 154 may or may not exist, and can represent logical connections, data flows, caller-callee relationships, ontological connections, etc.

The application matcher 130 extracts the set of matching applications 136 by comparing the candidate applications 140a, 140b, 140c, and 140d to the partially constructed application 138 and by filtering out all dissimilar candidate applications (e.g., candidate application 140c). As can be appreciated, a variety of factors can be used to determine similarity/dissimilarity, including, but not limited to, explicit naming/tagging of the applications or components, the presence of identical or similar components, and a pattern of connections between components. As can be appreciated, component based similarity can be based on identity (containing exactly the same set of components that are in the partially constructed application), partial matching (some of the components are in the partially constructed application), inexact matching (matching components that have similar function, but are not identical), and/or any other matching schemes. Based on the similarities of the non-filtered candidate applications with the partially constructed application, the application matcher 130 then identifies similar portions 156, for example, by labeling the components and/or connections of the application as similar.

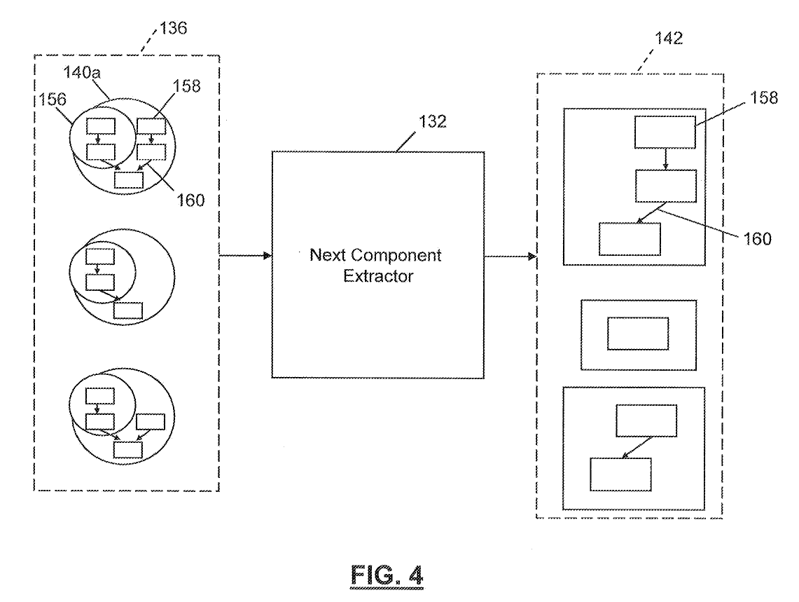

Turning now to FIG. 4, a block diagram illustrates the next component extractor of FIG. 2 in accordance with various aspects of the present disclosure. The next component extractor 132 generates the component set 142 based on the similar portions 156 of the set of matching applications 136. For example, for each application 140a, each component 158 and/or connection 160 that is NOT in the similar portions 156, the component 158 and/or connection 160 is extracted to the component set 142.

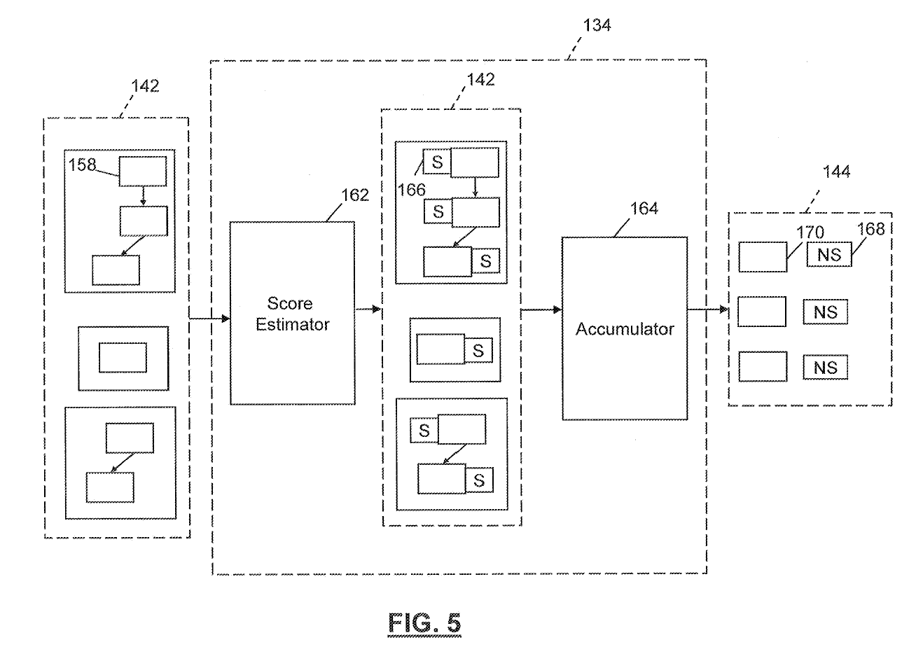

Turning now to FIG. 5, a block diagram illustrates the next component sorter 134 of FIG. 2 in accordance with various aspects of the present disclosure. The next component sorter 134 includes a score estimator 162 and an accumulator 164. The score estimator 162 computes and assigns each component 158 in the component set 142 a unique score 166. The score 166 is a measure of how appropriate that component would be as a “next component”. The score 166 may be based on the input/output types of the component, considered in relationship to the similar portions 156 (FIG. 3) in the application set 136 (FIG. 3). Alternatively, the score 166 may be based on a connected path length, if the components have connections. For example, in an application containing components and connections V->X->Y->Z, if Z is labeled, then Y might be considered to be a better recommendation than X, since Y is directly connected to Z, while X is connected only indirectly (through Y). Y would be assigned to a higher score 166 than X. As can be appreciated, various other scoring techniques can be similarly employed to assign an appropriate score to the components.

The accumulator 164 generates the recommendation 144 based on the scores 166. In one example, the accumulator 164 computes a normalized score 168 for each component type in the component set 142 based on the associated scores 166. The normalized score 168 is set equal to the sum of all scores 166 for the similar or the same components divided by the total number of different components. The accumulator 164 then ranks the components based on the normalized score 168 and generates the recommendation 144 based on the ranking. The recommendation 144 includes the predicted next component 170 and the normalized score 168.

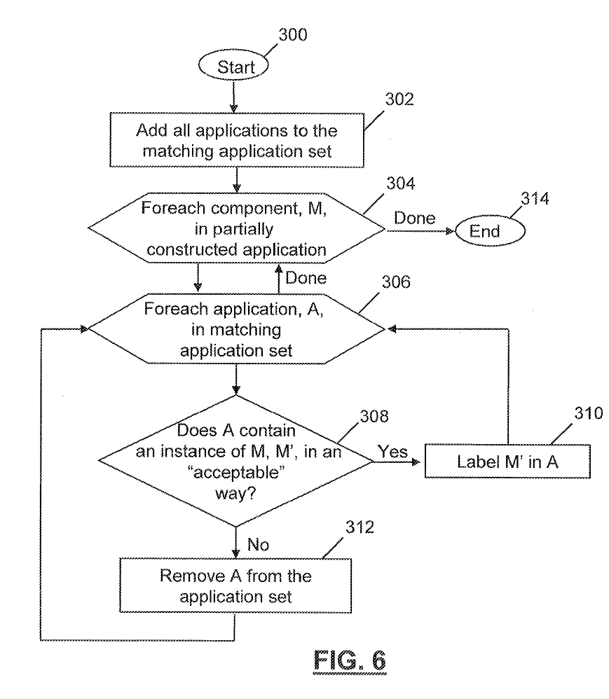

Turning now to FIG. 6, a flowchart illustrates an application matching method that can be performed by the application matcher 130 of FIG. 2 in accordance with various aspects of the present disclosure. As can be appreciated in light of the disclosure, the order of operation within the method is not limited to the sequential execution as illustrated in FIG. 6, but may be performed in one or more varying orders as applicable and in accordance with the present disclosure.

In one example, the method may begin at block 300. All the candidate applications are added to the matching application set at block 302. The partially constructed application is then evaluated at block 304. For each component (M) of the partially constructed application at block 304, each candidate application (A) is evaluated to determine whether the candidate application includes the same component (M) or a similar component (M′) at block 308. If the candidate application contains a same or similar instance of the component of the partially constructed application at block 308, then the component of the candidate application is labeled to indicate that it is the same or similar at block 310. Otherwise, if the candidate application does not contain a same or similar instance of the component of the partially constructed application at block 308, the candidate application is removed from the application set at block 312.

The method iterates on all components in the partially constructed application. Once processing of each component is complete at block 304, the method may end at block 314.

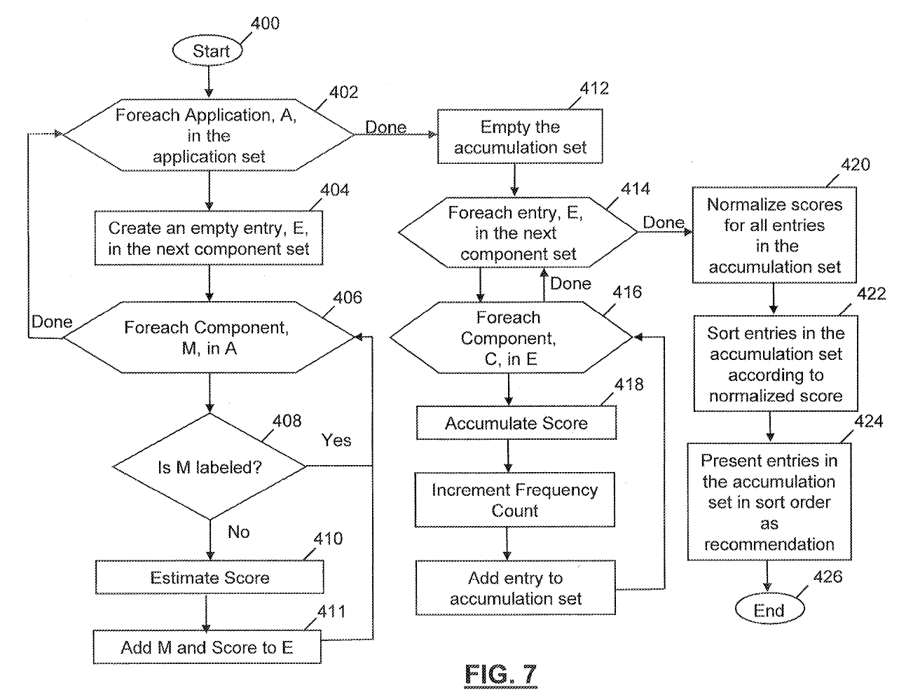

Turning now to FIG. 7, a flowchart illustrates a next component prediction method that can be performed by the next component extractor 132 and the next component sorter 134 of FIG. 2 in accordance with various aspects of the present disclosure. As can be appreciated in light of the disclosure, the order of operation within the method is not limited to the sequential execution as illustrated in FIG. 7, but may be performed in one or more varying orders as applicable and in accordance with the present disclosure.

In one example, the method may begin at block 400. Each application in the application set is processed at block 402. For each application (A) at block 402, an empty entry (E), in the next component set is created at block 404. Each component in the application is then processed at block 406. For each component (M) in the application at block 406, a check is made to see if the component has been labeled at block 408, as described above. If the component is not labeled at block 408, then the component is a potential “next component” and is added to the corresponding entry of the component set at block 410. The score is estimated and saved to the corresponding entry at block 411. If however, the component is labeled at block 408, the method continues to process the next components at block 406.

Once each component, for each application in the application set has been processed at block 402-411, the recommendation is generated at blocks 412-424. In one example, an empty accumulation set is created at block 412. Each entry (E) in the component set is then processed at block 414. For each entry in the component set at block 414, and for each component (M) in the entry, the corresponding score is added to a cumulative score for that component type at block 417 and a frequency count is incremented at block 418. The component, cumulative score, and the frequency count are then added as an entry to the accumulation set for that component type at block 418.

Once all entries in the next component set have been processed at block 414, the cumulative scores are normalized for each entry in the accumulation set at block 420. Normalization is performed by dividing the cumulative score for an entry by the frequency count for that entry. Once normalized at block 420, the normalized scores can be used as a sort key, to sort or rank the entries in the accumulation set at block 422. Finally, the components in the accumulation set or a subset of the components are presented in sort order (e.g., high to low) as recommendations at block 424. Thereafter, the method may end at block 426.

As described above, the recommendations are based on the structure of previously-constructed applications. As can be appreciated, a variety of other types of information, beyond structure, might be employed to generate the recommendations. Such other information can include, but is not limited to: application-level tagging or metadata, component-level tagging or metadata, runtime behavior (accumulated via logging, for example), developer-imposed structure (such as groupings), etc. As can also be appreciated, knowledge of the component actually selected by the developer can be used by the component recommendation system 128 (FIG. 2) in generating subsequent recommendations.

In various embodiments, a selection of a component within the recommendation by the developer can be fed back into the system to improve future recommendations. In one example, the selected component is fed back into the next component extractor 132 (FIG. 2) for aiding in the selection process. In yet another example, the selected component is fed back into the next component sorter 132 (FIG. 2) to provide further criteria for computing the score 166.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of recommending a next component, the method comprising:
identifying one or more candidate software applications based on a first similarity metric, wherein the one or more candidate software applications include one or more reusable software components;
identifying one or more candidate software components from the one or more reusable software components based on a second similarity metric;
estimating a score for each of the one or more candidate software components based on a composition of the one or more candidate software applications; and
generating a recommendation based on the scores of each of the one or more candidate components.

2. The method of claim 1 further comprising computing a normalization for each of the scores and wherein the generating the recommendation is based on the normalizations.

3. The method of claim 2 wherein the generating the recommendation is based on a ranking of the normalizations.

4. The method of claim 1 wherein the estimating the score is based on at least one of an input type of the component, an output type of the component, a relationship to a similar portion of the candidate application, and a connected path length.

5. The method of claim 1 wherein the first similarity metric and the second similarity metric are based on at least one of a component name, a component tag, a presence or absence of similar components, and a pattern of connection between components.
